(19) United States
(12) Patent Application Publication
(10) Pub. No.: US 2026/0036717 A1
(43) Pub. Date: Feb. 5, 2026

(54) OPTICAL ELEMENT, LIGHT SOURCE APPARATUS, LIGHT SCANNING APPARATUS, AND IRRADIATION APPARATUS

(71) Applicant: CANON KABUSHIKI KAISHA, Tokyo (JP)

(72) Inventor: Genichiro KUDO, Tochigi (JP)

(21) Appl. No.: 19/242,466

(22) Filed: Jun. 18, 2025

(30) Foreign Application Priority Data
Jul. 31, 2024 (JP) 2024-124791

(51) Int. Cl. G02B 1/00; B82Y 20/00; G02B 26/12; G03B 21/20

(52) U.S. Cl. CPC G02B 1/007; B82Y 20/00; G02B 26/125; G03B 21/208

(57) ABSTRACT

An optical element includes a substrate, and a plurality of meta-atoms provided on the substrate. A first power is generated by the optical element in a first cross section. A second power is generated by the optical element in a second cross section orthogonal to the first cross section. The first power and the second power are different from each other.

### BACKGROUND

### Field of the Technology

The present disclosure relates to an optical element, a light source apparatus, a light scanning apparatus, and an irradiation apparatus.

### Description of the Related Art

Japanese Patent No. 2682641 discloses a light source apparatus in which an aspherical lens is integrated with a cover glass for protecting a light source.

### SUMMARY

An optical element according to one aspect of the present disclosure includes a substrate, and a plurality of meta-atoms provided on the substrate. A first power is generated by the optical element in a first cross section. A second power is generated by the optical element in a second cross section orthogonal to the first cross section. The first power and the second power are different from each other. A light source apparatus, a light scanning apparatus, and an irradiation apparatus, each having the above optical element also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are cross-sectional views of an optical element according to a first embodiment.

FIG. 2 is a schematic diagram of a light source apparatus according to the first embodiment.

FIG. 3 is a schematic diagram of a laser beam in the first embodiment.

FIG. 4 is a schematic diagram of a surface of the optical element according to the first embodiment.

FIG. 5 is a perspective view of a meta-atom structure according to the first embodiment.

FIG. 6 illustrates a plurality of meta-atom structures according to the first embodiment.

FIG. 7 is a cross-sectional view of a structure in a meridional direction of a first surface according to the first embodiment.

FIG. 8 is a cross-sectional view of the structure in a sagittal direction of the first surface of the first embodiment.

FIG. 9 is a schematic diagram of a light source apparatus according to a second embodiment.

FIG. 10 is a schematic diagram of a surface of an optical element according to the second embodiment.

FIGS. 11A and 11B are cross-sectional views of a light source module according to the second embodiment.

FIG. 12 is a schematic diagram of a light scanning apparatus according to the second embodiment.

FIG. 13 is a cross-sectional view of a structure in a meridional direction of a first surface according to the second embodiment.

FIG. 14 is a cross-sectional view of a structure of a second surface in a sagittal direction according to the second embodiment.

FIG. 15 is a schematic diagram of a face recognition system according to a third embodiment.

FIG. 16 is a schematic diagram of a face recognition system according to a fourth embodiment.

FIG. 17 is a cross-sectional view of an optical system according to a fifth embodiment in an in-focus state at infinity.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

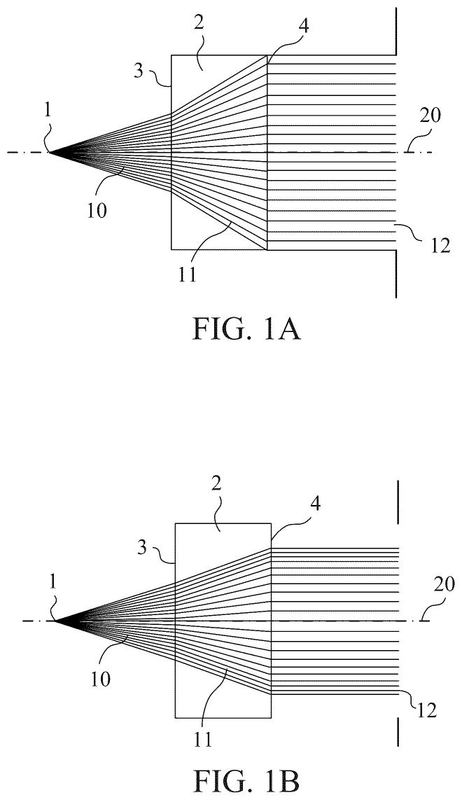

FIGS. 1A and 1B are cross-sectional views of an optical element (metasurface element) according to this embodiment. FIGS. 1A and 1B are meridional and sagittal cross-sectional views, respectively.

The optical element includes a substrate 2 and a plurality of meta-atoms provided on the substrate 2. A first power is generated by the optical element in a first cross section. A second power is generated by the optical element in a second cross section orthogonal to the first cross section. The first power and the second power are different from each other. A light emitting point 1 emits a light beam 10. The substrate 2 is a transmissive substrate having a metasurface including a meta-atom structure and having anamorphic power. The substrate 2 is made of a material having a linear expansion coefficient of 5×10⁻⁵ [K−1] or less. In this embodiment, the substrate 2 is made of quartz glass having a linear expansion coefficient of 5×10⁻⁷. The substrate 2 has a first surface (R1 surface, incident surface) 3 which the light beam 10 enters, and a second surface (R2 surface, exit surface) 4 configured so that the light beam passing through the first surface 3 is irradiated (incident) with a desired intensity distribution on a rear optical system (not illustrated) or a liquid crystal panel. An optical axis 20 is set to pass through the light emitting point 1 and the coordinate origin for the first surface 3 and the second surface 4. In this embodiment, the first surface 3 and the second surface 4 are flat, and the thickness of the substrate 2 is 0.775 mm. This configuration can reduce the deterioration of optical performance due to the expansion of the substrate 2 caused by temperature. Therefore, the optical element having anamorphic power according to this embodiment can be disposed near a light source that generates a large amount of heat. Unlike a refractive lens having a curvature on the surface, since the thickness is constant, the curvature change due to temperature rise is unlikely to occur. The meta-atom structure includes a structure having a shape smaller than the wavelength of the incident light. The structure is disposed so that a phase retardation profile (phase difference) set according to the position is satisfied in a desired wavelength band in order to realize the desired optical performance. The metasurface is configured so that the power generated by the multiple meta-atoms in the first cross section and the power in the second cross section orthogonal to the first cross section are different from each other. In this embodiment, one of the first and second cross sections is a cross section in the meridional direction, and the other is a cross section in the sagittal direction. It is highly difficult to manufacture the cover glass integrated with the aspherical lens such as that disclosed in Japanese Patent No. 2682641. In particular, it is difficult to process an aspherical surface with a glass material, and it becomes difficult to create a surface shape that is beneficial to miniaturization. In comparison, according to the present disclosure, high performance can be achieved by adjusting the intensity distribution and angle of the output light beam in two orthogonal directions to desired values. The metasurface is formed on at least one of the first surface 3 and the second surface 4.

In FIG. 1A, the first surface 3 has negative power and converts the light beam 10 into a diverging light beam 11. The second surface 4 has positive power and converts the diverging light beam 11 into an output light beam 12, which is a parallel light beam. The metasurface is set so that the light beam width of the output light beam 12 is wider than that without the metasurface, and the light beam density of the output light beam 12 is approximately uniform and parallel. The light beam density is defined by the light beam in a case where the light beam 10 is divided at an equal angle, and when the metasurface is not provided, it is determined so that the off-axis (periphery) is coarser than the on-axis (center).

In FIG. 1B, the metasurface is set so that the light beam width of the output light beam 12 is equivalent to that without the metasurface. The metasurface is set so that the light ray density of the emitted light beam 12 becomes denser as the position moves from the optical axis 20 toward the periphery and parallel.

Table 1 illustrates the optical parameters of the optical element according to this embodiment.

TABLE 1

| | | | Refractive |
|---|---|---|---|
| | | | Index |
| | r | d | λ = 520 nm |
| Light Emitting Point | | 1 | |
| R1 | ∞ | 0.775 | 1.46 |
| R2 | ∞ | | |

In this embodiment, a diffractive metasurface with anamorphic power is formed on both of the first surface 3 and the second surface 4. The metasurface may be a dispersion-controlled diffraction surface for the purpose of correcting chromatic aberration. The phase function p that determines the power of the metasurface is expressed by the following equation:

$$φ ( y , z ) = \frac{2 π}{m λ} ( {C}_{5} {y}^{2} + {C}_{14} {y}^{4} + {C}_{27} {y}^{6} + {C}_{3} {z}^{2} + {C}_{10} {z}^{4} + {C}_{21} {y}^{6} )$$

Here, m is a diffraction order, and c3, c5, c10, c14, c21, and c27 are phase coefficients. The terms related to c3, c10, and c21 are terms that represent the power in the sagittal direction. Table 2 illustrates the phase coefficients of this embodiment.

TABLE 2

1

| m | R1 | R2 |
|---|---|---|
| c3 | 1.64E+00 | −8.12E−01 |
| c5 | 1.30E+00 | −7.67E−01 |
| c10 | −7.23E+00 | 1.69E−01 |
| c14 | 1.51E+00 | 3.73E−02 |
| c21 | 1.54E+01 | 2.46E−01 |
| c27 | −1.21E+01 | 3.14E−02 |

In this embodiment, the phase is determined using a designed wavelength k of 520 nm and a diffraction order m of 1. In this embodiment, the second, fourth, and sixth order coefficients are set in the meridional cross section and the sagittal cross section. The first surface 3 has the phase coefficients c3 and c5 set to positive, and has negative power on the optical axis (including the vicinity of the optical axis). Thereby, the light beam width near the optical axis can be increased. In addition, by setting negative power, the influence of the wavelength dispersion can be canceled with the second surface 4, and the influence of the wavelength fluctuation, etc., can be reduced.

### Explanation of Laser Element

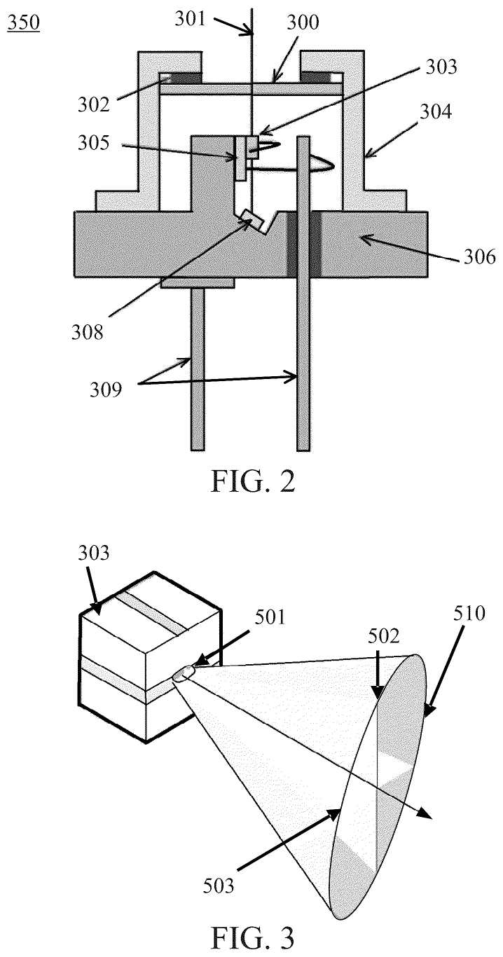

FIG. 2 is a schematic diagram of a semiconductor laser 350, which is an example of a light source apparatus according to this embodiment. A laser chip (laser crystal) 303 and a monitor photodiode 308 are sealed by a sealing material 302 in contact with a reference part (not illustrated) in a package 304 having an optical element 300 with a metasurface. The laser chip 303 is attached to a heat sink 306 via a submount 305. The photodiode 308 is disposed on the rear side of the laser chip 303, and is irradiated with a laser beam (laser light, radiation light) from the rear side of the laser chip 303. The electrodes of the laser chip 303 and the photodiode 308 are connected to corresponding terminals 309. The laser beam 301 output from the front side of the laser chip 303 is radiated to the outside through the optical element 300.

FIG. 3 is a schematic diagram of the laser beam 301 emitted from the laser chip 303. In the laser chip 303, the laser beam 301 is emitted from a rectangular near-field pattern (NFP) 501 as a light emitting point, and enters the optical element 300. Reference numeral 510 denotes an elliptical far-field pattern (FFP) where a minor axis direction of NFP 501 is a major axis 502 and a major axis direction of NFP 501 is the minor axis 503.

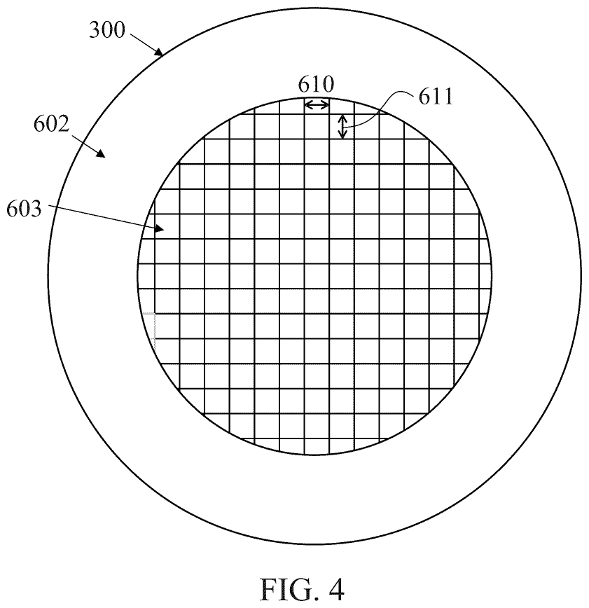

FIG. 4 is a schematic diagram of the surface of optical element 300. The optical element 300 includes a circular planar substrate (transmissive substrate) with a diameter of 2.0 mm. A holding portion (reference portion) 602 is an attachment portion of a mechanism that abuts against a holder or the like. A meta-atom structure 603 is a virtual area obtained by dividing the planar substrate into rectangular regions at regular intervals, and includes a meridional length 610 and a sagittal length 611 that are the same length. The meta-atom structures 603 are uniformly and without gaps arranged within ranges of diameters of 0.7 mm and 1.6 mm on first surface 3 and second surface 4, respectively.

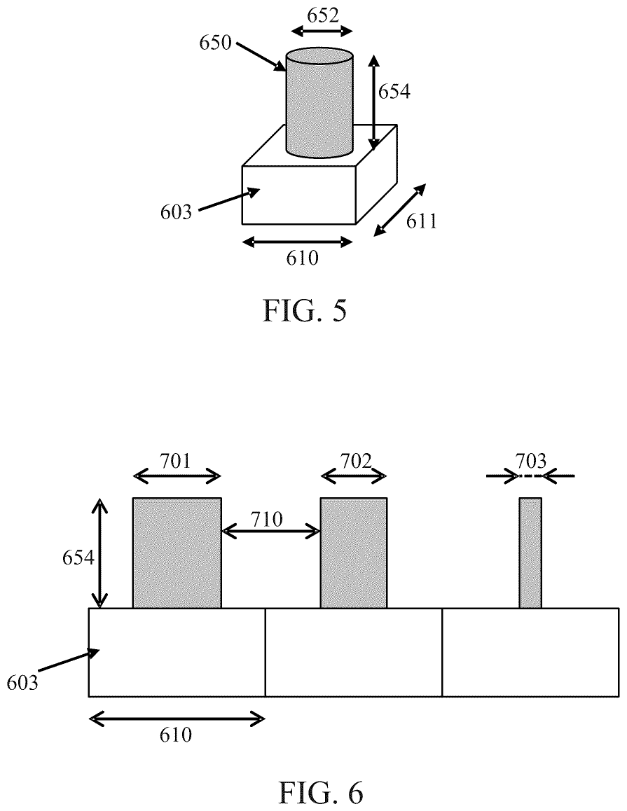

FIG. 5 is a perspective view of the meta-atom structure 603. The meridional length 610 and sagittal length 611 of the meta-atom structure 603 are 350 nm. A cylindrical structure 650 is formed on the top of the meta-atom structure 603 with a height of 1200 nm. The structure 650 is made of silicon nitride (Si₃N₄), and has a constant height 654 over the entire area, and a length (maximum diameter) 652 in the meridional and sagittal directions that varies according to the position. The length 652 may be approximately the same as the designed wavelength, and is set to, for example, 500 nm or less. In this embodiment, the structure 650 is cylindrical, but the present disclosure is not limited to this example. The structure 650 may be, for example, a square prism or a triangular prism. In addition, a plurality of structures 605 may be arranged in a combination of different shapes, such as a cylindrical shape and a square prism shape.

FIG. 6 illustrates three adjacent meta-atom structures 603. In this embodiment, the meridional length 610 is set to 350 nm, and the phase is changed continuously by changing meridional lengths 701, 702, and 702 of the structures 650 within the effective range. In other words, a structure interval 710 is changed according to the position to create a phase difference. In this embodiment, the changes in length of the structures from the center to the periphery in the meridional and sagittal directions are different from each other.

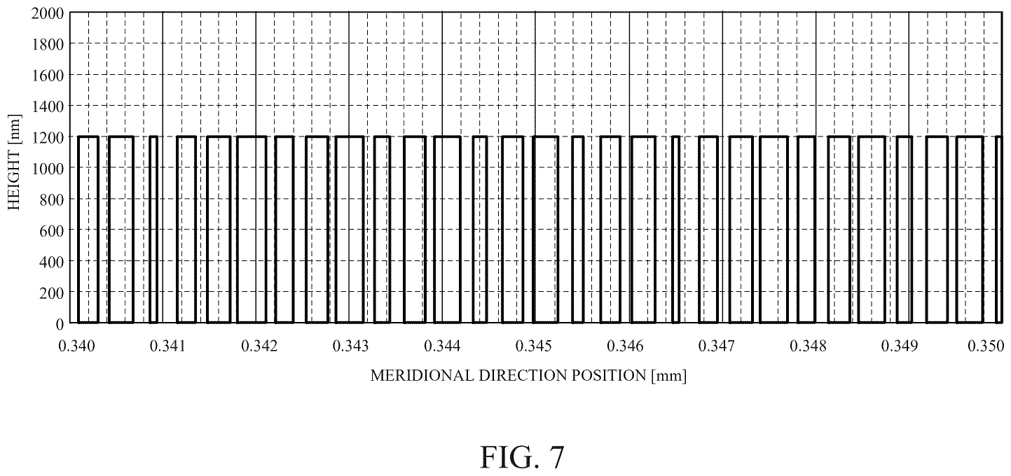

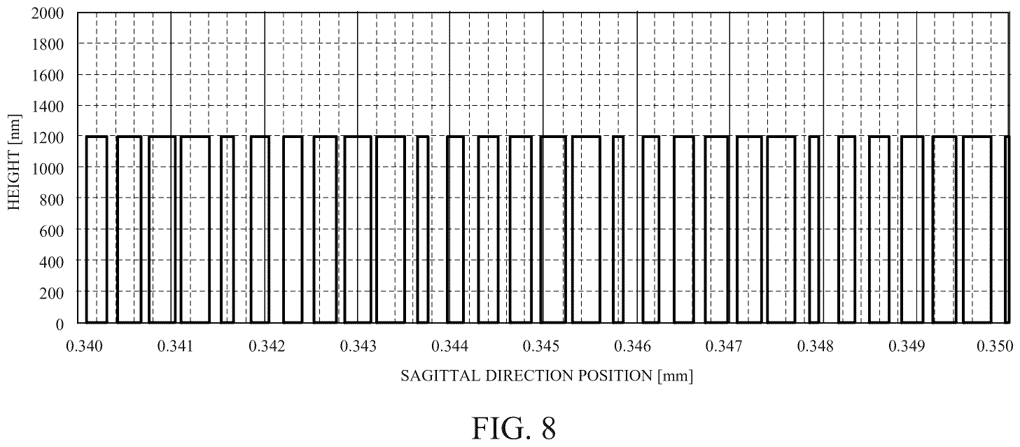

FIG. 7 is a cross-sectional view of the structures in the meridional direction of the first surface 3. FIG. 8 is a cross-sectional view of the structures in the sagittal direction of the first surface 3. This embodiment can provide anamorphic power by making structure length changes different from each other from an on-axis position to an off-axis position in two orthogonal cross sections in the meridional and sagittal directions. The number of structures on the first surface 3 is about 4 million in a 2 mm square range. In this embodiment, the minimum length of the structures is 45 nm, the minimum structure interval is 45 nm, and the optical element 300 can be created by lithography.

The optical element 300 may satisfy at least one of the following inequalities (1) and (2):

$$0 \text{.1} < \vert P 1 \vert \qquad ( 1 )$$

$$0.2 < \vert P 2 / P 1 \vert < 0. 95 \qquad ( 2 )$$

where P1 is one of the powers of the first and second cross sections having a larger absolute value and P2 is the other of the powers having a smaller absolute value.

Satisfying at least one of the inequalities (1) and (2) can provide the optical element 300 with a reduced size and ease of manufacture.

In this embodiment, as described above, one of the first and second cross sections is a cross section in the meridional direction, and the other is a cross section in the sagittal direction. In this embodiment, the power of the cross section in the meridional direction is 0.434, and the power of the cross section in the sagittal direction is 0.204, so the powers P1 and P2 are 0.434 and 0.204, respectively. Therefore, |P2/P1| is 0.469, and inequalities (1) and (2) are satisfied.

Inequalities (1) and (2) may be replaced with inequalities (1a) and (2a) below. In particular, inequality (2a) can reduce performance degradation due to assembly performance.

$$0.2 < \vert P 1 \vert < 10000. \qquad ( 1 a )$$

$$0.3 < \vert P 2 / P 1 \vert < 0.90 \qquad ( 2 a )$$

Inequalities (1) and (2) may be replaced with inequalities (1b) and (2b) below:

$$0.3 < \vert P 1 \vert < 10 0. \qquad ( 1 b )$$

$$0.35 < \vert P 2 / P 1 \vert < 0.85 \qquad ( 2 b )$$

As described above, the configuration according to this embodiment can provide an optical element that can easily provide a small and highly functional light source apparatus.

The optical element according to this embodiment may be mounted, for example, on a light scanning apparatus, a light source for an optical pickup apparatus, a laser projector, AR glasses, and an irradiation apparatus for face authentication.

### Second Embodiment

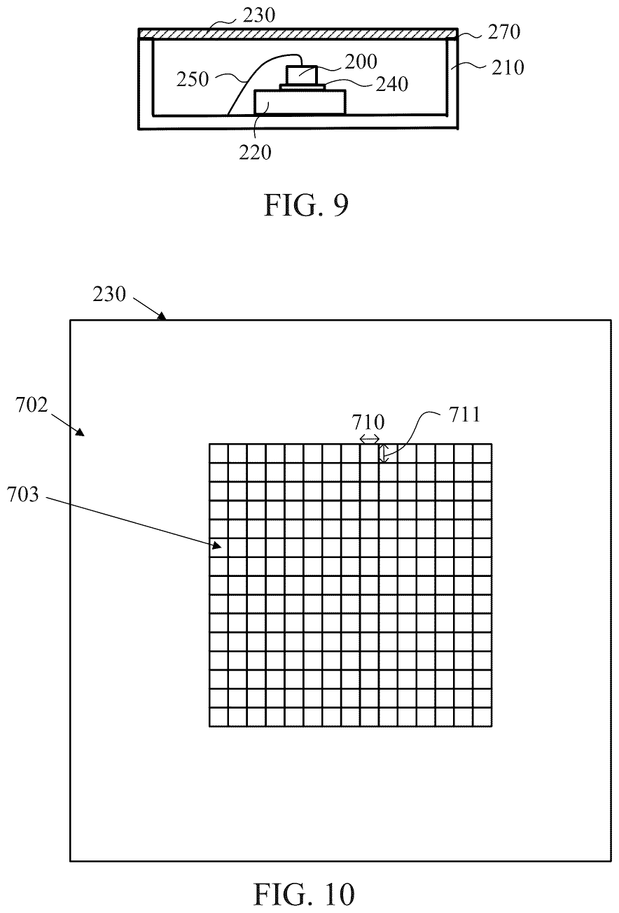

FIG. 9 is a schematic diagram of a VCSEL package, which is an example of the light source apparatus according to this embodiment. The VCSEL package has amounted substrate (or printed circuit board) 210, a VCSEL (light emitting element) 200, and an optical element 230. The mounted substrate 210 has a size equal to the outer dimensions of the optical element 230. The VCSEL 200 is mounted on the mounted substrate 210 via a submount substrate 220 and a die bond material (bonding layer) 240. An electrode on the upper surface of the VCSEL 200 is connected to wiring formed on the mounted substrate 210 by a wire 250. The optical element 230 is adhesively fixed to a support portion 270 via an adhesive material (not illustrated). This structure can suppress the intrusion of dust into the inside of the VCSEL package.

FIG. 10 is a schematic diagram of the surface of the optical element 230. The optical element 230 includes a 5 mm square planar substrate. The optical element 230 has a holding portion 702 and a meta-atom structure 703. The meta-atom structure 703 includes a meridional length 710 and a sagittal length 711 that are equal lengths of 400 nm, and a cylindrical structure is formed on the upper portion with a height of 700 nm. The planar substrate is made of S-bsl7 (OHARA), and the height is constant over the entire range, and the lengths in the two directions change according to the position. In this embodiment, the optical element 230 is made rectangular, so it is attached based on a plane parallel to the meridional and sagittal directions. Therefore, it is possible to reduce the optical axis center rotation error during attachment and the deterioration of optical performance due to the optical axis center rotation error inherent to the anamorphic element.

In this embodiment, the first surface 3 of the optical element 230 is a rotationally symmetric surface, the second surface 4 is an optical surface with anamorphic power, and the intensity distribution and angle of the emitted light beam are set to desired values. Thereby, high functionality can be achieved.

Table 3 illustrates the optical parameters of the optical element according to this embodiment.

TABLE 3

| | | | Refractive |
|---|---|---|---|
| | | | Index |
| | r | d | λ = 790 nm |
| Light Emitting Point | | 5 | |
| R1 | ∞ | 0.25 | 1.51 |
| R2 | ∞ | | |

In this embodiment, a diffraction type metasurface with anamorphic power is formed on both of the first surface 3 and the second surface 4. The phase function (p that determines the power of the metasurface is expressed by the following equation:

$$φ ( y , z ) = \frac{2 π}{m λ} ( {C}_{5} {y}^{2} + {C}_{14} {y}^{4} + {C}_{27} {y}^{6} + {C}_{3} {z}^{2} + {C}_{10} {z}^{4} + {C}_{21} {y}^{6} )$$

Here, m is a diffraction order, and c3, c5, c10, c14, c21, and c27 are phase coefficients. The terms related to c3, c10, and c21 are terms that represent the power in the sagittal direction. Table 4 illustrates the phase coefficients of this embodiment.

TABLE 4

1

| m | R1 | R2 |
|---|---|---|
| c3 | −1.00E−01 | −1.22E−02 |
| c5 | −1.00E−01 | |
| c10 | 1.00E−03 | −7.36E−05 |
| c14 | 1.00E−03 | |
| c21 | | |
| c27 | | |

This embodiment determines a phase using a designed wavelength K of 790 nm and a diffraction order m of 1. In this embodiment, the second and fourth order coefficients are set in the meridional and sagittal cross sections. The first surface 3 is a rotationally symmetric surface with convex power near the optical axis. The phase coefficients c3 and c5 are equal to the phase coefficients c10 and c14. The second surface 4 is a surface that has power only in the sagittal direction, and is configured so that the light beam emitted from the second surface 4 becomes convergent light in the sagittal direction.

In this embodiment, the structure length changes from the center to the periphery. Since it has anamorphic power, it is set to be different in the meridional and sagittal cross sections.

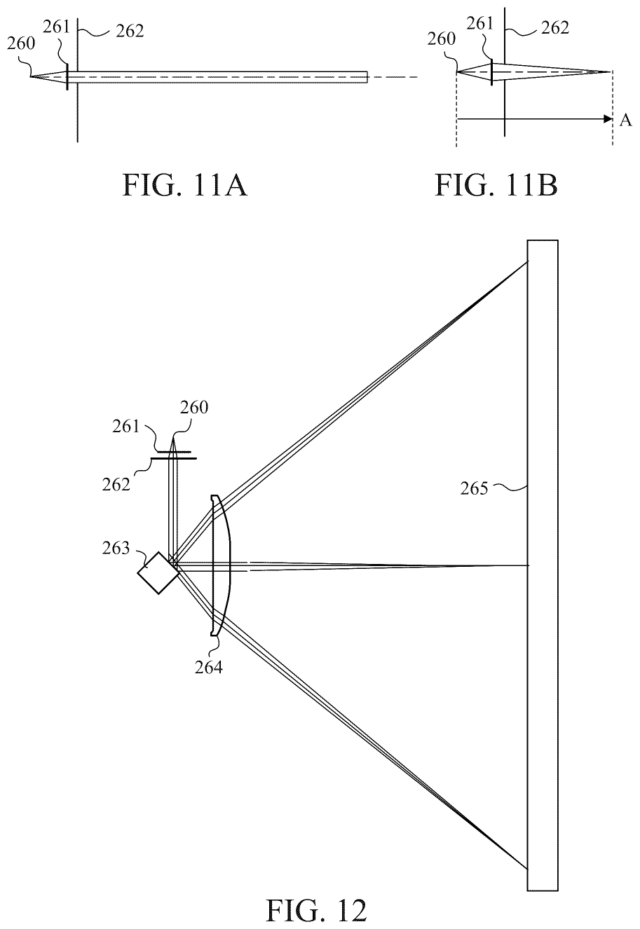

FIGS. 11A and 11B are cross-sectional views of a light source module (laser light source module) according to this embodiment. FIGS. 11A and 11B are meridional and sagittal cross-sectional views, respectively. A light source 260 includes a VCSEL and emits a light beam. A substrate 261 includes a meta-atom structure and has a metasurface with anamorphic power, and converts the light beam emitted from the light source 260 into a parallel light beam in the meridional direction and into a convergent light beam in the sagittal direction. In this embodiment, the substrate 261 is made of a material with a linear expansion coefficient of 72×10⁻⁷. Therefore, this embodiment can place an optical element with anamorphic power near a light source that generates a large amount of heat. In addition, unlike a refractive lens with a curvature on its surface, the thickness is constant, so that the curvature change due to temperature rise is unlikely to occur. An aperture stop (diaphragm or slit member) 262 determines a light beam width. A phase function of the metasurface and a distance from the light source 260 to the metasurface are determined so that the light is condensed at a light condensing position A that is 45.3 mm away from the light source 260 in the sagittal direction.

FIG. 12 is a schematic diagram of a light scanning apparatus using the light source module according to this embodiment. The substrate 261 converts a light beam emitted from the light source 260 into a parallel light beam in the main scanning direction and into a convergent light beam in the sub-scanning direction, and forms a substantially linear image on a deflection surface (deflection reflective surface) of a light deflector 263 in the sub-scanning cross section. The first cross section is the main scanning cross section, and the second cross section is the sub-scanning cross section. The aperture stop 262 limits a light beam passing through the substrate 261. The light deflector 263 is a light deflector that includes a rotating polygon mirror with a plurality of deflection surfaces and is rotatable by a drive unit (not illustrated) such as a motor. The light deflector 263 deflects a light beam from the light source 260 to scan a scanned surface 265 in the main scanning direction. An fθ lens 264 forms a spot on the scanned surface 265 using the deflected light beam from the light deflector 263. The deflection surface and the scanned surface 265 are set in a substantially conjugate relationship in the sub-scanning cross section, and an imaging positional shift due to the tilt (face tilt) of the deflection surface is reduced. Using the light source module can reduce a distance from the light source 260 to the light deflector 263.

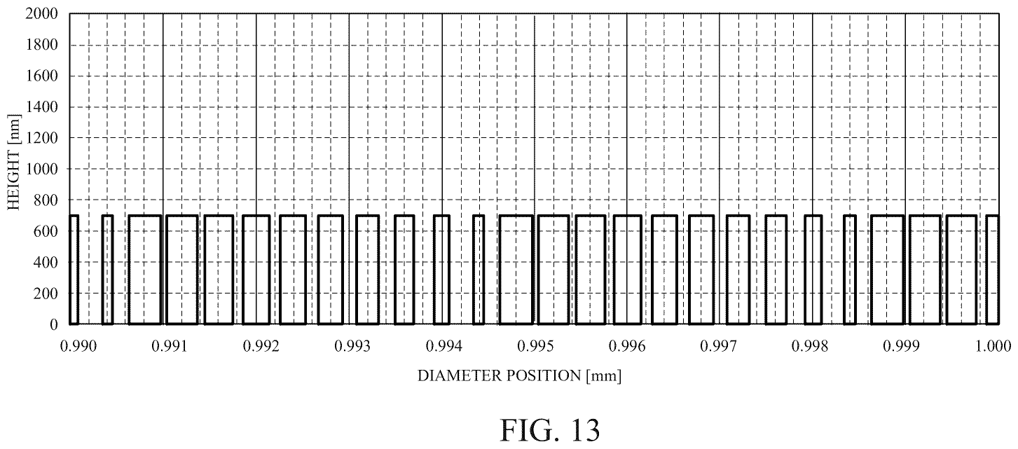

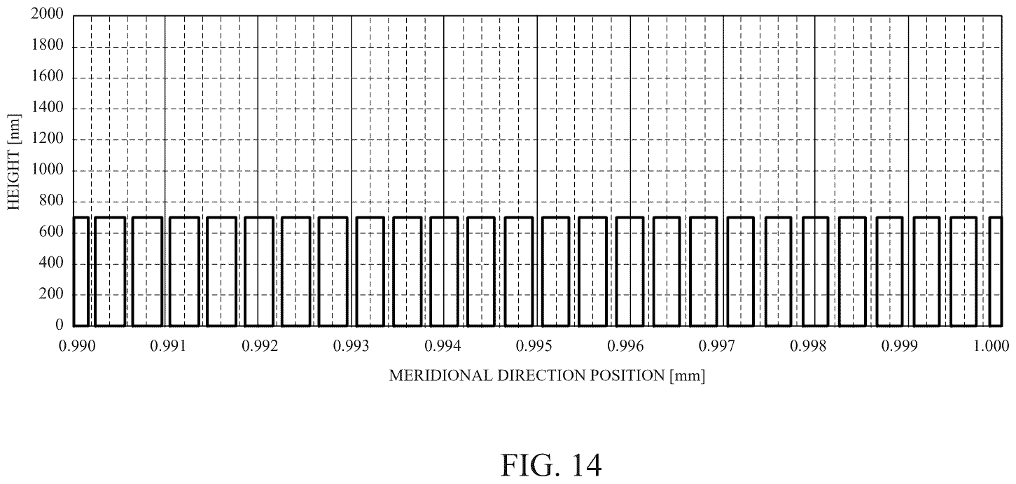

FIG. 13 is a cross-sectional view of the structure in the meridional direction of the first surface 3. FIG. 14 is a cross-sectional view of the structure in the sagittal direction of the second surface 4. In this embodiment, the first surface 3 has a rotationally symmetric shape, and the second surface 4 is a surface having power only in the sagittal direction. This embodiment can provide anamorphic power by making structure length changes in different from each other from an on-axis position to an off-axis position in two orthogonal cross sections in the meridional and sagittal directions. The number of structures on the first surface 3 is about 10,000 in a 2 mm square range. The minimum structure length is 52 nm, the minimum structure interval is 52 nm, and the optical element can be created by lithography.

The optical element may satisfy at least one of inequalities (1) and (2), where P1 is one of the powers of the first and second cross sections having a larger absolute value and P2 is the other of the powers having a smaller absolute value.

In this embodiment, the power of the cross section in the meridional direction is 0.200 and the power of the cross section in the sagittal direction is 0.224, so the powers P1 and P2 are 0.224 and 0.200, respectively. Therefore, |P2/P1| is 0.894, and inequalities (1) and (2) are satisfied.

As described above, the configuration according to this embodiment can provide an optical element that can easily provide a small and highly functional light source apparatus.

### Third Embodiment

Face recognition has recently been an increasing demand due to the demand for improved security. In general, face recognition is a technology that detects a human face area from a digital image and identifies an individual, but a technology that distinguishes between flat and three-dimensional objects is also known. The conventional square pattern projection method can identify a face in a dark place using a light projection illuminator. However, an irradiation range is wide, and a light intensity of each dot is low, and detection accuracy reduces. In a case where an emitter light amount is increased, power consumption increases.

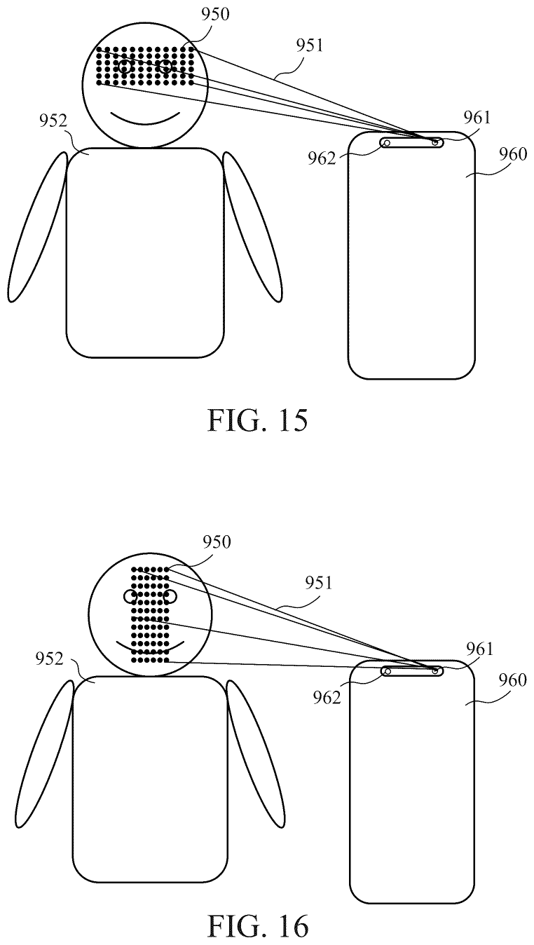

FIG. 15 is a schematic diagram of a face recognition system using the anamorphic light source apparatus according to this embodiment. A high-performance mobile phone (smartphone) 960 includes a light projection unit (laser dot irradiation apparatus) 961 and a camera 962 on the upper part. Reference numeral 950 denotes an infrared laser dot as invisible light. The anamorphic light source apparatus mounted on the high-performance mobile phone 960 causes light beams from a VCSEL light source having a plurality of light emitting points (not illustrated) to pass through an optical element as an anamorphic metasurface element, and to emit it from the light projection unit 961. A dot pattern 951 emitted from the light projection unit 961 is projected onto a rectangular irradiation area. In this embodiment, it is projected horizontally onto an object 952 such as a face. In this embodiment, the longitudinal cross section of the irradiation area is the first cross section, and the lateral cross section of the irradiation area is the second cross section. The position of the dot pattern 951 can be imaged by the camera 962, calculated, and compared to be used as information for identifying an individual along with a planar image.

Using an anamorphic light source apparatus, this embodiment can provide a face recognition system that uses a laser light amount highly efficiently by irradiating laser dots only to the range required for face recognition without changing the light emitting point number and arrangement of the light source. In the anamorphic light source apparatus according to this embodiment, the height of the optical element is set so that the second surface 4 of the first embodiment generates high-order diffracted light.

This embodiment changes the meta-atomic structure of the first surface 3 and/or the second surface 4 to emit high-order diffracted light, but similar effects can be obtained by separately providing a diffraction element.

The face recognition technology may determine the dot position by the anamorphic light source apparatus using artificial intelligence (AI) and deep learning (one of deep learning and machine learning techniques).

As described above, the configuration according to this embodiment can provide an optical element that can easily provide a small and highly functional light source apparatus.

### Fourth Embodiment

FIG. 16 is a schematic diagram of a face authentication system using the anamorphic light source apparatus according to this embodiment. This embodiment will discuss only the configuration that differs from that of the third embodiment, and will omit the same configuration.

This embodiment differs from the third embodiment in that the dot pattern is made vertically long. This embodiment uses the vertical unevenness of the face as a feature amount, and performs recognition using data that is asymmetric in the longitudinal direction, thereby improving recognition accuracy compared to that of the configuration according to the third embodiment. This embodiment uses a vertically long dot pattern, but can acquire a similar effect using a cross pattern or the like.

### Fifth Embodiment

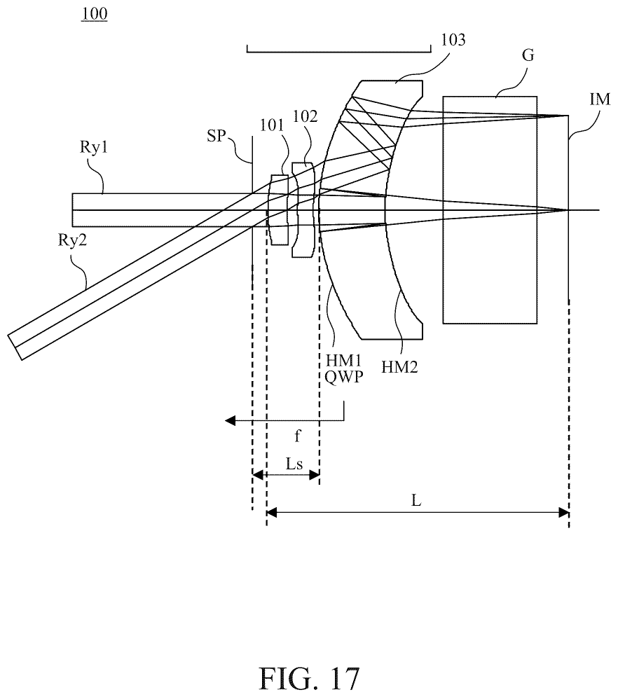

FIG. 17 is a cross-sectional view of the optical system 100 in an in-focus state (on an object) at infinity. The optical element described in the first embodiment may be used in part of the optical system 100. The optical system 100 includes, arranged in this order from the object side to the image side, an open aperture (aperture stop) SP, a first positive lens (first lens) 101, a second negative lens (second lens) 102, a third lens 103 having a first transmissive reflective surface HM1 and a second transmissive reflective surface HM2, and a member G such as a glass block such as a prism and a sensor protective glass. The third lens 103 has a quarter waveplate QWP on the image side of the first transmissive reflective surface HM1.

The first positive lens 101, the second negative lens 102, and the third lens 103 form a focusing unit f Focusing is performed by moving each lens that constitutes the focusing group f together in the optical axis direction. Ry1 represents an on-axis ray, and Ry2 represents the most off-axis ray. The optical system 100 is configured to guide the on-axis ray Ry1 to the image plane IM.

As described above, the configuration according to this embodiment can provide an optical element that can easily provide a small and highly functional light source apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the present disclosure can provide an optical element that can easily provide a small and highly functional light source apparatus.

This application claims the benefit of Japanese Patent Application No. 2024-124791, which was filed on Jul. 31, 2024, and which is hereby incorporated by reference herein in its entirety.

What is claimed is:

1. An optical element comprising:
a substrate; and
a plurality of meta-atoms provided on the substrate,
wherein a first power is generated by the optical element in a first cross section,
wherein a second power is generated by the optical element in a second cross section orthogonal to the first cross section, and
wherein the first power and the second power are different from each other.

2. The optical element according to claim 1, wherein the substrate is made of a material having a linear expansion coefficient of 1×10⁻⁵ [K−1] or less.

3. The optical element according to claim 1, wherein the following inequality is satisfied:
$$0.2 < \vert P 2 / P 1 \vert < 0. 95$$
where P1 is power having a larger absolute value of the first power and the second power, and P2 is power having a smaller absolute value of the first power and the second power.

4. The optical element according to claim 1, wherein the following inequality is satisfied:
$$0.1 < \vert P 1 \vert$$
where P1 is power having a larger absolute value of the first power and the second power.

5. The optical element according to claim 1, wherein a linear expansion coefficient of the meta-atoms is smaller than that of the substrate.

6. The optical element according to claim 5, wherein the substrate is made of quartz glass, and the meta-atom is made of silicon nitride.

7. The optical element according to claim 1, wherein the plurality of meta-atoms include a plurality of meta-atoms having different maximum diameters.

8. The optical element according to claim 7, wherein each of the maximum diameters of the plurality of meta-atoms is 500 nm or less.

9. The optical element according to claim 1, wherein the power generated by the plurality of meta-atoms has negative power on an optical axis.

10. The optical element according to claim 1, wherein a surface on which the plurality of meta-atoms are provided is a dispersion-controlled diffraction surface.

11. Alight source apparatus comprising:
the optical element according to claim 1; and
a light source configured to emit a light beam.

12. The light source apparatus according to claim 11, wherein the optical element and the light source are integrated as a single module.

13. The light source apparatus according to claim 11, wherein the light beam emitted from the light source apparatus is a parallel light beam.

14. Alight scanning apparatus comprising:
the light source apparatus according to claim 11; and
a deflector configured to deflect the light beam from the light source apparatus to scan a scanned surface in a main scanning direction,
wherein the first cross section is a main scanning cross section, and
wherein the second cross section is a sub scanning cross section.

15. An irradiation apparatus comprising:
the light source apparatus as claimed in claim 11; and
a light projecting unit configured to project a dot pattern onto a rectangular irradiation area using the light beam from the light source apparatus,
wherein the first cross section is a longitudinal cross section of the rectangular irradiation area, and
wherein the second cross section is a lateral cross section of the rectangular irradiation area.
